(19) United States
(12) Patent Application Publication
(10) Pub. No.: US 2008/0172618 A1
(43) Pub. Date: Jul. 17, 2008

(54) NAVIGATION SYSTEM OF WEB BROWSER AND METHOD THEREOF

(75) Inventor: Sang-jun HAN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/749,845

(22) Filed: May 17, 2007

(30) Foreign Application Priority Data
Jan. 11, 2007 (KR) 10-2007-0003398

(51) Int. Cl. G06F 3/048

(52) U.S. Cl. 715/738

(57) ABSTRACT

Provided are a navigation system of a web browser and a method thereof. The navigation system includes: a link area determination unit that determines whether a selected area is a link area; a computation unit that computes a distance from the link area if the selected area is not the link area; and a display that enlarges and displays the surroundings of the link area if the computed distance is within a predetermined range.

### CROSS-REFERENCE TO RELATED PATENT APPLICATION

This application claims the benefit of Korean Patent Application No. 10-2007-0003398, filed on Jan. 11, 2007, in the Korean Intellectual Property Office, the disclosure of which is incorporated herein in its entirety by reference.

### BACKGROUND OF THE INVENTION

1. Field of the Invention

The present invention relates to a web browser, and more particularly, to a navigation system of a web browser and a method thereof.

2. Description of the Related Art

FIG. 1 illustrates an example of a web page of the conventional portable web browser.

With the rapid development of a mobile memory and an information processing technique, there is a growing trend that a portable terminal provides not only a basic wireless telephone function but also a video communication function and an Internet function. The Internet may be connected through a screen of a mobile phone, a screen of a personal digital assistant (PDA), or a screen of a portable terminal to a user. In this case, a web page designed for a personal computer (PC) is displayed on the screen in a relatively small size. Since the web page is generally designed in consideration of an environment using a PC monitor, it is difficult to display the entire content of the web page on the screen of the portable terminal. Thus, in order to be displayed on the screen of the portable terminal, the content has to be displayed in a smaller size than when using a PC monitor. Accordingly, as shown in FIG. 1, it is difficult to correctly click coordinates linked on the screen. That is, when the web page designed in consideration of an environment using the PC monitor and a mouse is viewed without alteration through a small screen of the portable terminal by using an input device such as a direction key or a touch screen, it is difficult to correctly click a desired link.

### SUMMARY OF THE INVENTION

The present invention provides a navigation system of a web browser and a method thereof so that a link on the web page can be correctly clicked.

According to the present invention, a user is less likely to mistakenly click a wrong area. Therefore, it is possible to increase satisfaction of the user who uses a receiving terminal providing Internet access.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an example of a web page of the conventional portable web browser;

FIG. 2 is a block diagram of a navigation system of a web browser according to an exemplary embodiment of the present invention;

FIG. 3 illustrates a web page of a web browser according to an exemplary embodiment of the present invention; and

FIG. 4 is a flowchart of a navigation method of a web browser according to an exemplary embodiment of the present invention.

### DETAILED DESCRIPTION OF THE INVENTION

Hereinafter, exemplary embodiments of the present invention will be described in detail with reference to the accompanying drawings.

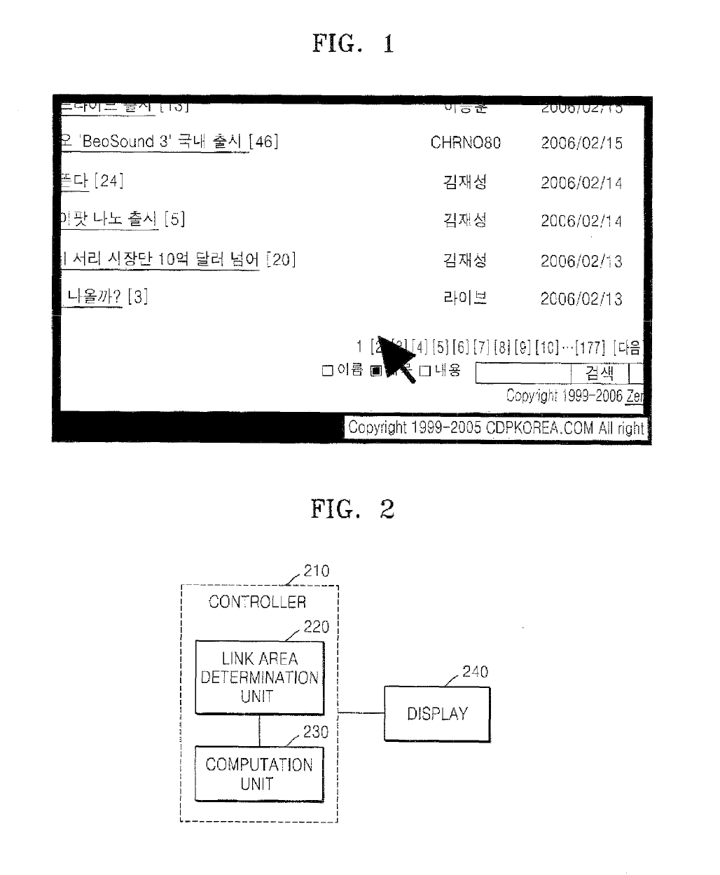

FIG. 2 is a block diagram of a navigation system of a web browser according to an exemplary embodiment of the present invention. The navigation system may be included in a receiving terminal that provides an Internet web browser, in particular, in a portable receiving terminal with a small screen. Furthermore, the navigation system may be included in a content provider server that provides Internet content.

Referring to FIG. 2, the navigation system includes a controller 210, which has a link area determination unit 220 and a computation unit 230, and a display 240.

The link area determination unit 220 determines whether an area clicked by a user on a web page is a link area. In general, when the user correctly clicks link coordinates by moving a cursor, a screen changes to a linked site. On the other hand, when the user clicks other areas than the link area, the screen does not change. In particular, a screen of a portable receiving terminal is smaller than that of a general personal computer (PC). Thus, it is not easy for the user to correctly click the link area.

If the area clicked by the user is not the link area, the computation unit 230 computes a distance between the area clicked by the user and the link area. Only when the distance obtained by the computation result is less than a predetermined value, it is determined that the user has attempted to click a link but failed. A distance between coordinates in the area selected by a user's click, and the link area may be measured by using a method of measuring the shortest distance, a method of measuring a distance from a center point, or a method of measuring the longest distance. In the method of measuring the shortest distance, if the shortest distance between the selected coordinates and the link area is within a predetermined range, it is determined that the user has attempted to click the link area within the predetermined range. In the method of measuring a distance from a center point, the distance between the center point of the link area and the selected coordinates is measured. In the method of measuring the longest distance, the longest distance between the coordinates clicked by the user and the link area is measured. In this manner, user's intention can be recognized according to the measured distances.

If the distance computed by the computation unit 230 is within the predetermined range, the display 240 enlarges and displays the surroundings of the link area having a distance within the predetermined range. Through the enlarged screen, the user can easily click exact coordinates of a desired link area by using a cursor. Specifically, the link area where the user has attempted to click is found by the distance computation, and the surroundings of the link area is enlarged and displayed so that the user can easily select the link area. In this case, an enlargement ratio and an enlargement area may be determined by the user or a designer.

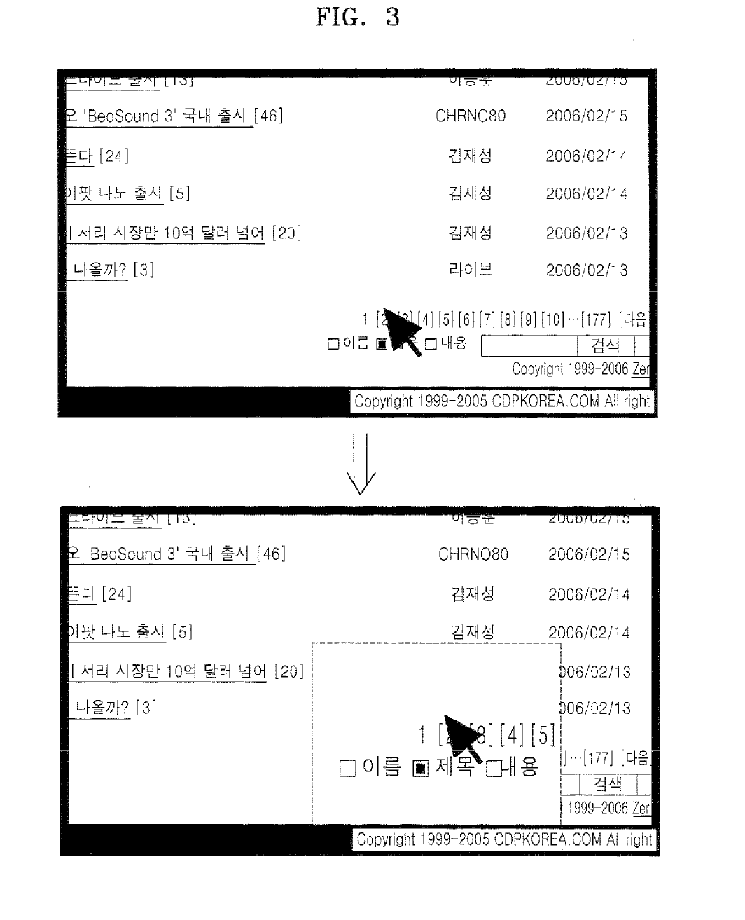

FIG. 3 illustrates a web page of a web browser according to an exemplary embodiment of the present invention.

Referring to FIG. 3, a screen displayed on the display 240 of the navigation system of the present invention is shown as an example. In order to click a link on the web page displayed on the screen, the user moves a cursor to click coordinates. Then, a receiving terminal recognizes the coordinates clicked by the user and determines whether the clicked coordinates are included in a link area. If the user has clicked the link area, the screen changes to a linked site. On the other hand, as shown in FIG. 3, if the user has failed to correctly click the link area, user's intention, that is, a link area where the user has attempted to click, is recognized. Then, the surroundings of the link area is enlarged and displayed so that the user can easily select the link area.

For example, the user may have intended to click a linked portion indicated by [2] in FIG. 3 so as to move to a corresponding web page but may have mistakenly clicked the surroundings of the portion [2] because of a small screen of a portable device and difficult operations of a touch screen or a direction key. In this case, a distance between the area clicked by the user and the link area is computed in the navigation system of the portable device, and then an area where the user has attempted to click is enlarged and displayed. When the enlarged screen is displayed, the link area is also enlarged by the same enlargement ratio as the screen. As a result, the user can easily click the link area.

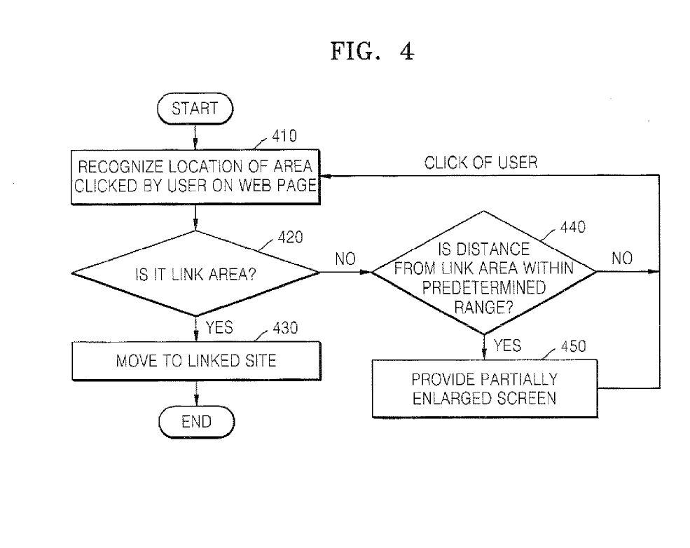

FIG. 4 is a flowchart of a navigation method of a web browser according to an exemplary embodiment of the present invention.

In operation 410, the controller 210 of the navigation system recognizes the location of an area clicked by the user on the web page. Specifically, coordinates of the location of the area clicked by the user on the web page displayed on the screen so as to recognize user's intention, that is, a site the user desires to access is accessed.

In operation 420, the area clicked by the user is determined whether it is a link area to be moved to another uniform resource locator (URL). If the user has clicked the link area, the procedure goes to operation 430, thereby moving to the linked area. Otherwise, the procedure goes to operation 440 without moving to any site.

In operation 440, a distance between the coordinates of the area clicked by the user and the link area is computed, and then whether the computed distance is within a predetermined range is determined. If the distance between the clicked area and the link area is within the predetermined range, it is determined that the user has intended to click the link area. The distance between the coordinates of the clicked area and the link area may be measured by using a method of measuring the shortest distance, a method of measuring a distance from a center point of the link area, or a method of measuring the longest distance.

If the distance between the coordinates of the area clicked by the user and the link area is within the predetermined range determined by a designer or the user, the procedure goes to operation 450. Thus, a partially enlarged screen is provided on which the surroundings of the link area is enlarged. An enlargement ratio and an enlargement area may vary depending on settings. When the partially enlarged screen is provided, the user may click the link area on the enlarged screen so as to move to the linked site. If the distance between the coordinates of the clicked area and the link area is out of the predetermined range determined by the user, the partially enlarged screen is not provided.

According to the present invention, a navigation system of a web browser and a method thereof are provided so that a link on the web page can be correctly clicked.

In addition, according to the present invention, a user is less likely to mistakenly click a wrong area. Therefore, it is possible to increase satisfaction of the user who uses a receiving terminal providing Internet access.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A navigation system of a web browser, comprising:
a link area determination unit that determines whether a selected area is a link area;
a computation unit that computes a distance from the link area if the selected area is not the link area; and
a display that enlarges and displays the surroundings of the link area if the computed distance is within a predetermined range.

2. The navigation system of claim 1, wherein the navigation system is included in a receiving terminal.

3. The navigation system of claim 2, wherein the receiving terminal is a portable receiving terminal.

4. The navigation system of claim 1, wherein the navigation system is included in a content provider server that provides a web page.

5. The navigation system of claim 1, wherein the computation unit computes a distance between the selected area and a center point of the link area.

6. The navigation system of claim 1, wherein the computation unit computes a shortest distance or a longest distance between the selected area and the link area.

7. A navigation method of a web browser, comprising:
determining whether a selected area is a link area;
computing a distance from the link area if the selected area is not the link area; and
enlarging and displaying the surroundings of the link area if the computed distance is within a predetermined range.

8. The navigation method of claim 7, wherein the web browser is included in a receiving terminal.

9. The navigation method of claim 8, wherein the receiving terminal is a portable receiving terminal.

10. The navigation method of claim 7, wherein, in the computing of a distance from the link area a distance between a center point of the link area and the selected area is computed.

11. The navigation method of claim 7, wherein, in the computing of a distance from the link area, a shortest distance or a longest distance between the selected area and the linked area is computed.

12. A computer-readable medium having embodied thereon a computer program for executing a navigation method of a web browser, the method comprising:
determining whether a selected area is a link area;
computing a distance from the link area if the selected area is not the link area; and
enlarging and displaying the surroundings of the link area if the computed distance is within a predetermined range.

13. The computer-readable medium of claim 12, wherein the web browser is included in a portable receiving terminal.
